(19) United States
(12) Patent Application Publication
(10) Pub. No.: US 2024/0178620 A1
(43) Pub. Date: May 30, 2024

(54) Electrical Connector

(71) Applicants: Tyco Electronics Holdings (Bermuda) No. 7 Limited, Hamilton (BM); Tyco Electronics (Shanghai) Co., Ltd., Shanghai (CN)

(72) Inventors: Lizhou (Leo) Li, Shanghai (CN); Xinjie (David) Zhang, Shanghai (CN); Kehao (Asroc) Chen, Taipei (TW); Ching Hsiang Chang, Taipei (TW)

(73) Assignees: Tyco Electronics Holdings (Bermuda) No. 7 Limited, Hamilton (BM); Tyco Electronics (Shanghai) Co., Ltd., Shanghai (CN)

(21) Appl. No.: 18/524,072

(22) Filed: Nov. 30, 2023

(30) Foreign Application Priority Data
Nov. 30, 2022 (CN) 202211534244.9

(51) Int. Cl. H01R 13/6581; H01R 12/71; H01R 13/514

(52) U.S. Cl. CPC H01R 13/6581; H01R 12/716; H01R 13/514

(57) ABSTRACT

An electrical connector comprises an outer housing, an insulating housing installed on the outer housing, a pair of terminal assemblies, and a shielding member. The terminal assemblies are installed in the insulating housing and are spaced apart from each other in a first direction to define an insertion space therebetween adapted to receive a connection terminal of a mating connector. Each terminal assembly includes a plurality of conductive terminals arranged in rows in a second direction perpendicular to the first direction. The plurality of conductive terminals of each terminal assembly include a signal terminal and a ground terminal. The shielding member is positioned at least partially between the two terminal assemblies in the first direction and includes a contact arm in electrical contact with the ground terminal.

### CROSS-REFERENCE TO RELATED APPLICATION

This application claims the priority benefit of Chinese Patent Application No. 202211534244.9 filed on Nov. 30, 2022, in the China National Intellectual Property Administration, the whole disclosure of which is incorporated herein by reference.

### FIELD OF THE INVENTION

Embodiments of the present disclosure generally relate to an electrical connector, and more specifically, to an electrical connector capable of improving signal integrity (SI) performance.

### BACKGROUND

Electrical connectors are electronic components that transmit and exchange electrical current, signals, or the like between electronic systems. The electrical connector, as a node, transmits electrical current or signals between devices, assemblies, apparatuses, and systems independently or together with the cable, and ensures that no signal distortion or changes in energy loss occurs between various systems. The electrical connector is a basic element necessary for the connection of a complete system. For example, input/output (I/O) modules are typically used to established connection between switches and between switches and servers.

With the continuous improvement of data rates and data volumes in high-speed links, the performance requirements of associated connectors is likewise increased. For example, the SI performance of the existing high-speed connectors may only meet the performance requirements for PCIe Gen5 but cannot meet the SI performance requirements for the next generation of connectors (i.e., PCIe Gen6).

### SUMMARY

According to an embodiment of the present disclosure, an electrical connector comprises an outer housing, an insulating housing installed on the outer housing, a pair of terminal assemblies, and a shielding member. The terminal assemblies are installed in the insulating housing and are spaced apart from each other in a first direction to define therebetween an insertion space for receiving a connection terminal of a mating connector. Each terminal assembly includes a plurality of conductive terminals arranged in rows in a second direction perpendicular to the first direction. The plurality of conductive terminals of each terminal assembly include a signal terminal and a ground terminal. The shielding member is positioned at least partially between the two terminal assemblies in the first direction and includes a contact arm in electrical contact with the ground terminal.

### BRIEF DESCRIPTION OF THE DRAWINGS

The invention will now be described by way of example with reference to the accompanying Figures, of which:

FIG. 1 is a perspective view schematically showing the structure of an electrical connector according to an exemplary embodiment of the present disclosure;

FIG. 2 is an exploded view schematically showing the structure of an electrical connector according to an exemplary embodiment of the present disclosure;

FIG. 3 is a bottom view schematically showing the structure of an electrical connector according to an exemplary embodiment of the present disclosure;

FIG. 4 is a sectional view taken along line A-A in FIG. 3, schematically showing the structure of the electrical connector according to an exemplary embodiment of the present disclosure;

FIG. 5 is an exploded view schematically showing the structure of an electrical connector according to another exemplary embodiment of the present disclosure;

FIG. 6 is a bottom view schematically showing the structure of the electrical connector according to another exemplary embodiment of the present disclosure;

FIG. 7 is a sectional view taken along line B-B in FIG. 6, schematically showing the structure of the electrical connector according to an exemplary embodiment of the present disclosure;

FIG. 8 is an exploded view schematically showing the structure of an electrical connector according to a yet another exemplary embodiment of the present disclosure;

FIG. 9 is a bottom view schematically showing the structure of the electrical connector according to a yet another exemplary embodiment of the present disclosure;

FIG. 10 is a sectional view taken along the line C-C in FIG. 9, schematically showing the structure of the electrical connector according to an exemplary embodiment of the present disclosure;

FIG. 11 is an exploded view schematically showing the structure of an electrical connector according to another exemplary embodiment of the present disclosure;

FIG. 12 is a bottom view schematically showing the structure of the electrical connector according to another exemplary embodiment of the present disclosure;

FIG. 13 is a sectional view taken along the line D-D in FIG. 12, schematically showing the structure of the electrical connector according to an exemplary embodiment of the present disclosure;

FIG. 14 is an exploded view schematically showing the structure of an electrical connector according to still another exemplary embodiment of the present disclosure;

FIG. 15 is a bottom view schematically showing the structure of the electrical connector according to still another exemplary embodiment of the present disclosure;

FIG. 16 is a sectional view taken along the line E-E in FIG. 15, schematically showing the structure of the electrical connector according to an exemplary embodiment of the present disclosure; and

FIG. 17 is a schematic diagram showing the SI performance of a conventional connector and the SI performance of an electrical connector according to an exemplary embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

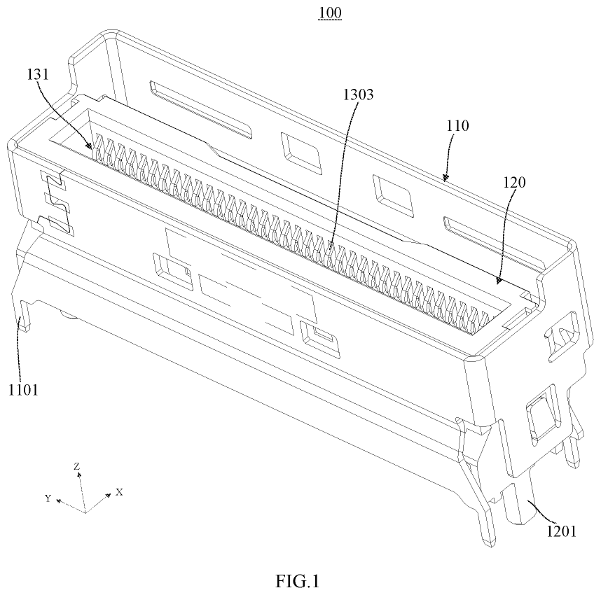

FIG. 1 schematically illustrates an electrical connector according to an exemplary embodiment of the present disclosure, which is configured to establish a signal connection/electrical connection between, for example, a circuit board of an electric apparatus and a mating connector. The electrical connector 100 comprises an insulating housing 120 and terminal assemblies 131 installed in the insulating housing 120. The insulating housing 120 is made of a plastic part such as liquid-crystal polymer (LCP), for example. Optionally, in some applications, the electrical connector 100 may further comprise an outer housing 110 supported by a metal material such as 304 stainless steel, in which the insulating housing 120 is installed. In some examples, as shown, the outer housing 110 may be formed with a first installation leg 1101 for installing on the circuit board, and/or the insulating housing 120 may also be formed with a second installation leg 1201 for installing on the circuit board.

In the illustrated embodiments, the electrical connector 100 comprises two terminal assemblies 131 installed in the insulating housing 120, the two terminal assemblies 131 being spaced apart from each other in a first direction X to define therebetween an insertion space or a mating port for receiving connection terminals of the mating connector. The two terminal assemblies 131 may be symmetrically arranged in the insulating housing 120. Each terminal assembly 131 comprises a plurality of conductive terminals arranged in rows. For example, the plurality of conductive terminals of each terminal assembly 131 may be arrayed in one or more rows in a second direction Y perpendicular to the first direction X.

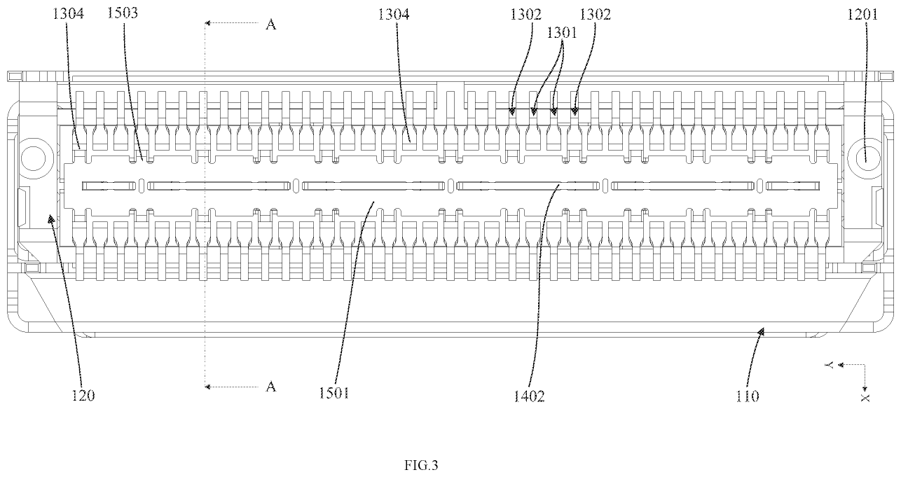

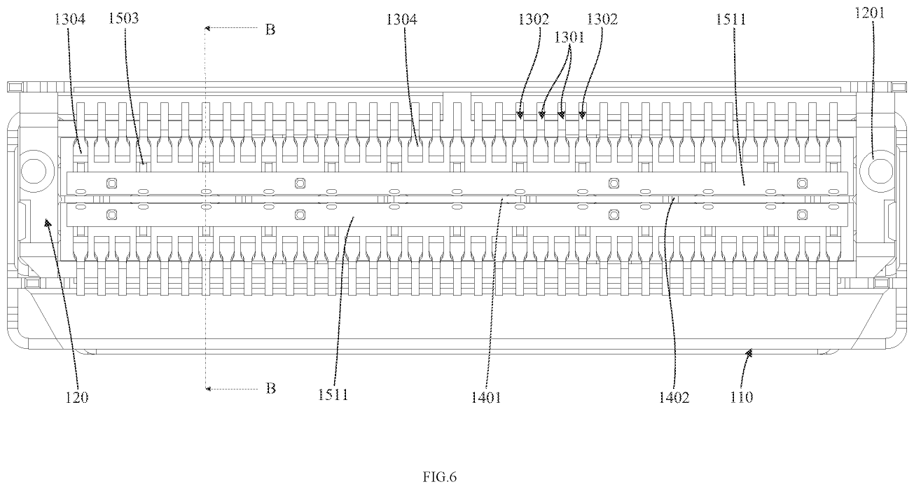

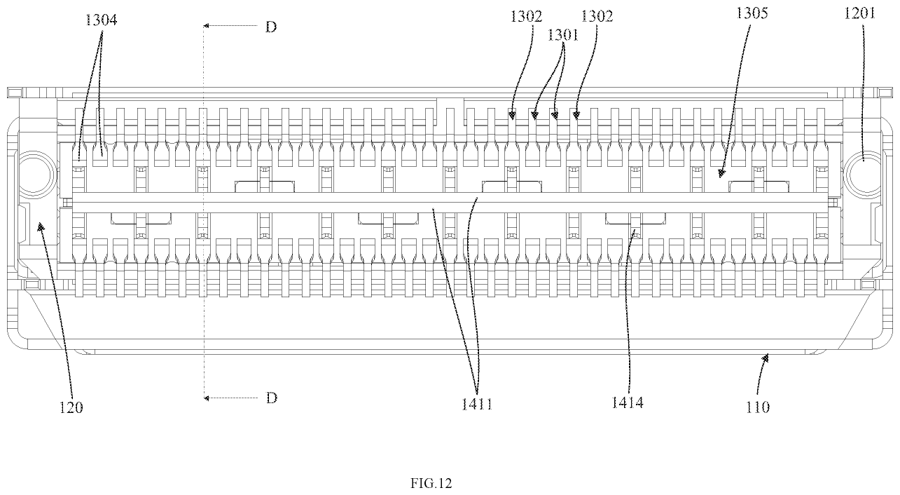

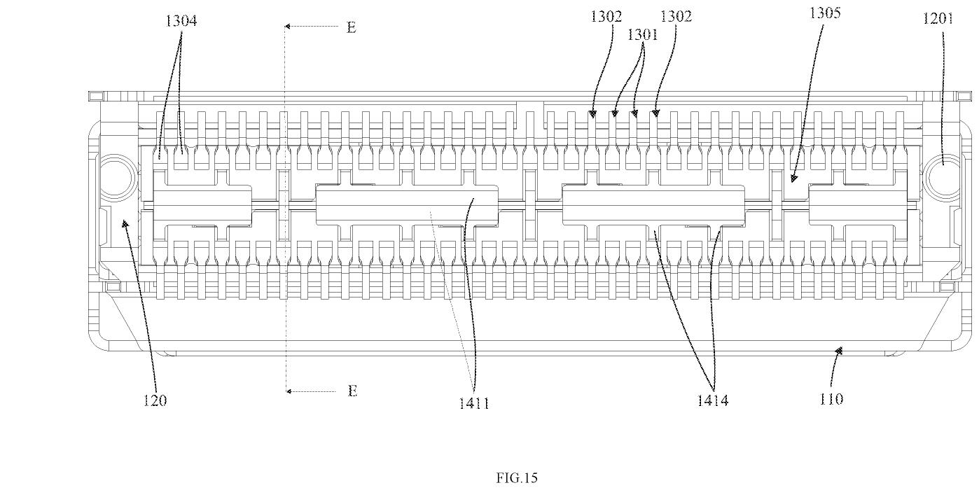

As an example, the plurality of conductive terminals of each terminal assembly 131 comprise a signal terminal 1301, a ground terminal 1302, and/or a power terminal. For example, as shown in FIGS. 3, 6, 9, 12 and 15, in each row of conductive terminals, signal terminals 1301 (e.g., two differential signal terminals) are arranged between two adjacent ground terminals 1302 or one or more ground terminals are provided between adjacent signal terminals, so as to achieve signal shielding effect and reduce signal interference.

The plurality of conductive terminals of each terminal assembly 131 may comprise at least one pair of differential signal terminals 1301 and at least one corresponding pair of ground terminals 1302. Each pair of ground terminals 1302 are positioned on two opposite sides of the corresponding pair of differential signal terminals 1301 in the second direction Y, so as to provide signal shielding effect between pairs of differential signal terminals in the same row.

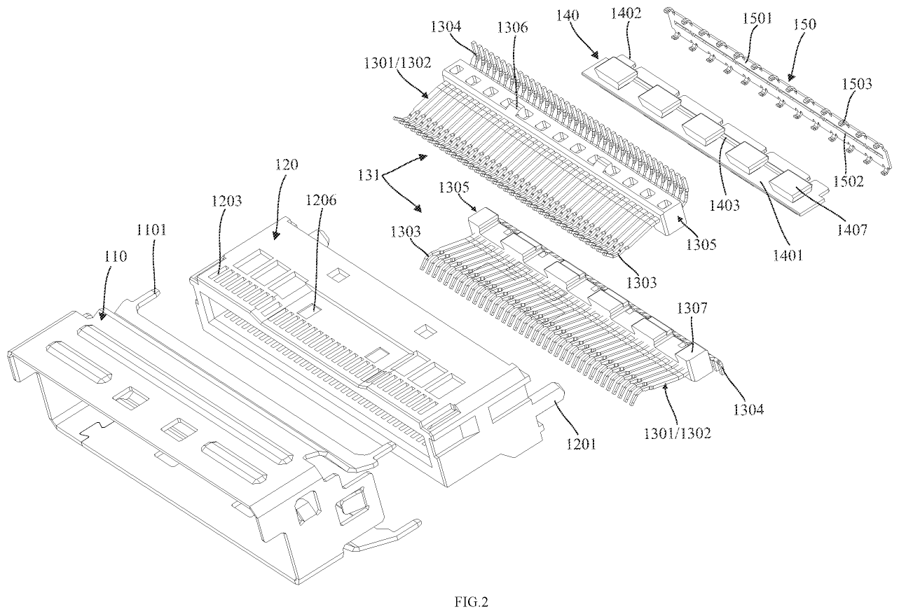

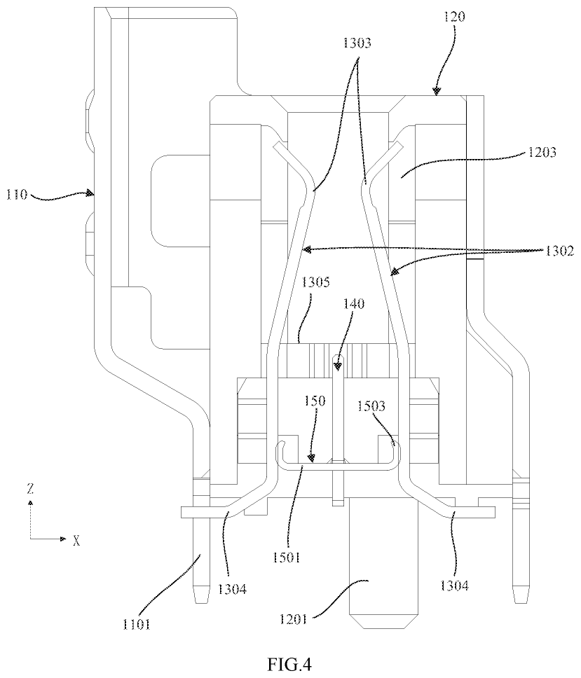

Each conductive terminal may comprise a contact section 1303 (e.g., an elastic arm) at an end and an installation section 1304 (e.g., a welding foot) at the opposite end. The contact section 1303 is configured to be in electrically contact with a connection terminal of the mating connector, and the installation section 1304 is configured to be installed (e.g., welded) onto the circuit board, for example, welded onto a welding pad on the circuit board, thereby realizing the installation and electrical connection of the electrical connector to the circuit board. As an example, a hole 1203 (see FIGS. 2 and 4) may be formed in a side wall of the insulating housing 120, and the contact section 1303 may be partially positioned in the hole 1203 (see FIG. 4), so as to allow the contact section 1303 to be deflected or deformed in the first direction X, thereby adapting to the insertion by connection terminals of mating connectors having different sizes.

In exemplary embodiments, the electrical connector further comprises a shielding member 140, which is at least partially positioned between the two terminal assemblies 131 in the first direction X, for example, at least partially positioned between the signal terminals 1301 of the two terminal assemblies 131. This provides further signal shielding effect on the signal terminals in two adjacent terminal assemblies 131, thereby improving SI. In this way, the connector may meet, PCIe Gen6 Si requirements, so that the electrical connector can be applied in high-speed link data transmissions, e.g., can be used as a high-speed I/O connector.

In the first direction X, the shielding member 140 is positioned at least between two adjacent terminal assemblies 131, or between portions, which are close to the installation section 1304, of the signal terminals 1301 in the adjacent rows of conductive terminals. The shielding member 140 may be made of a variety of conductive materials and may be grounded in a variety of ways. For example, the shielding member 140 may be electrically connected with the ground terminal 1302 directly or indirectly, or electrically connected with ground components of electric apparatus or circuit boards thereof.

FIGS. 2-4 schematically shows the structure of an electrical connector according to an exemplary embodiment of the present disclosure. As shown, the electrical connector 100 further comprises a grounding member 150 in electrical contact with the ground terminal 1302, and the shielding member 140 is electrically connected with the ground terminal 1302 via the grounding member 150. The grounding member 150 in contact with the shielding member 140 may be formed and arranged in various forms. In the embodiment shown in FIGS. 2-4, the grounding member 150 comprises a grounding body 1501, which may be formed into, for example, a substantially plate shape extending in the second direction Y and oriented perpendicular to a third direction Z orthogonal to the first direction X and the second direction Y, and the grounding body 1501 has one or more middle sockets 1502 extending substantially in the second direction Y. The middle socket 1502 is configured to allow the shielding member 140 to be at least partially inserted therein.

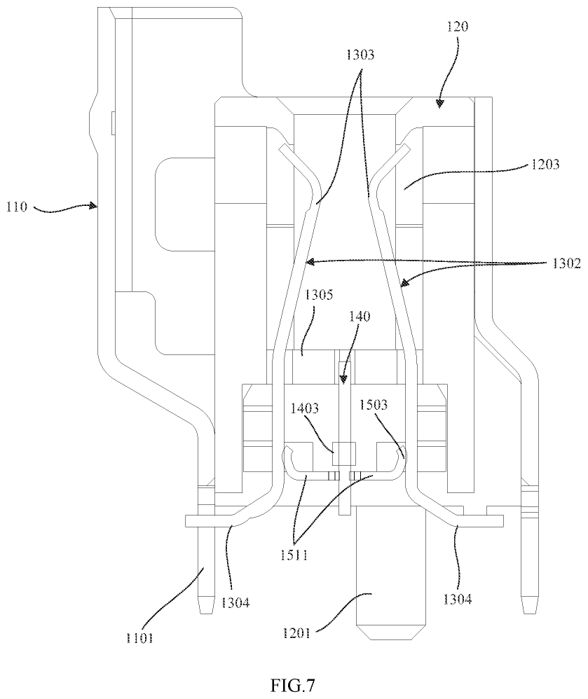

In some examples, as shown in FIGS. 2-7, the grounding member 150 comprises a contact projection 1503 extending from the grounding body 1501 toward the ground terminal 1302 to contact a corresponding ground terminal 1302. Exemplarily, as shown, a plurality of contact projections 1503 are formed on the edges of the two opposite sides of the grounding body 1501, and the contact projection 1503 can be positioned to contact a portion of the ground terminal 1302 close to the installation section 1304. In other examples, the grounding body of the grounding member may also directly contact the ground terminal.

In the embodiments shown in FIG. 2-10, the shielding member 140 comprises a shielding body 1401, which may be formed into, for example, a substantially plate shape extending in the second direction Y and oriented perpendicular to the first direction X, so as to be partially inserted into the middle socket 1502 of the grounding member 150. As an example, the shielding member 140 may further comprise one or more contact legs 1402 extending from the shielding body 1401 in the third direction Z to be inserted into the middle socket 1502.

In some examples, as shown in FIGS. 2, 5 and 8, a butting portion 1403 may be formed on a side or two opposite sides of the shielding body 1401. The butting portion 1403 may be formed in a form of a flange or a convex rib, so as to butt against the grounding body 1501 when the shielding member 140 is inserted into the middle socket 1502.

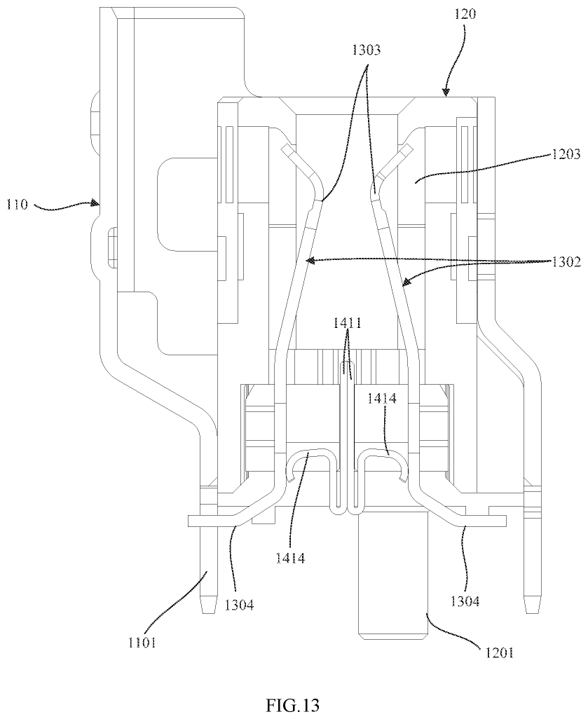

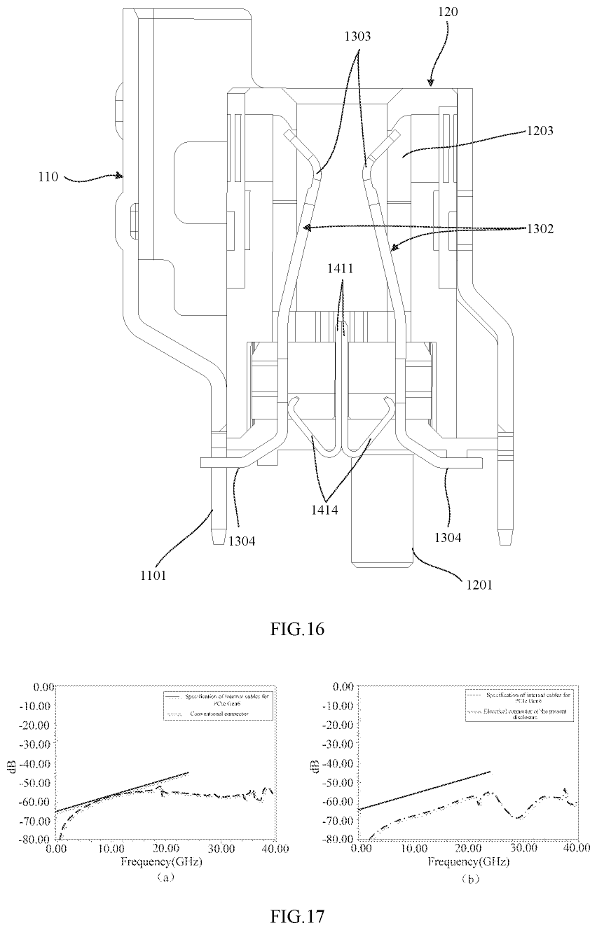

As shown in FIGS. 2-16, each terminal assembly 131 may further comprise an installation base 1305, which for example extends substantially in a shape of a long strip in the second direction Y. The plurality of conductive terminals of each terminal assembly 131 are installed or fixed in the installation base 1305 in the form of one or more rows. The installation base 1305 is provided within the insulating housing 120 and is fixed relative to the insulating housing 120. For example, a projection 1306 may be formed on an outer wall of the installation base 1305, while a corresponding slot or hole 1206 may be formed in a side wall of the insulating housing 120. The projection 1306 may be clamped or engaged into the slot or hole 1206 to fix the installation base 1305 to the insulating housing 120, so that the terminal assembly 131 is fixedly retained in the insulating housing 120. It will be understood that this retaining manner is only an example, and the terminal assembly may also be retained or installed within the insulating housing in other appropriate ways.

In addition, the shielding member 140 may also be retained or fixed onto the installation base 1305. As an example, as shown in FIGS. 2, 5 and 8, a plurality of protrusions 1307 spaced apart from each other are formed on a side of each installation base 1305 facing another terminal assembly 131. A gap or groove is defined between adjacent protrusions 1307, while a plurality of bumps 1407 are formed on a side or two opposite sides of the shielding body 1401 facing a corresponding installation base 1305. Each bump 1407 is adapted to be at least partially positioned in the groove between adjacent protrusions 1307 of corresponding installation bases 1305. For example, the shape of the bump 1407 is matched with the shape of the groove between the protrusions 1307, and a corresponding protrusion 1307 is at least partially positioned in the gap between the adjacent bumps 1407, and thus the shielding body 1401 of the shielding member 140 can be clamped between the two installation bases 1305 of the two terminal assemblies 131. It will be understood that this retaining manner is only an example, and the shielding member may also be retained or fixed relative to the installation base in other appropriate ways.

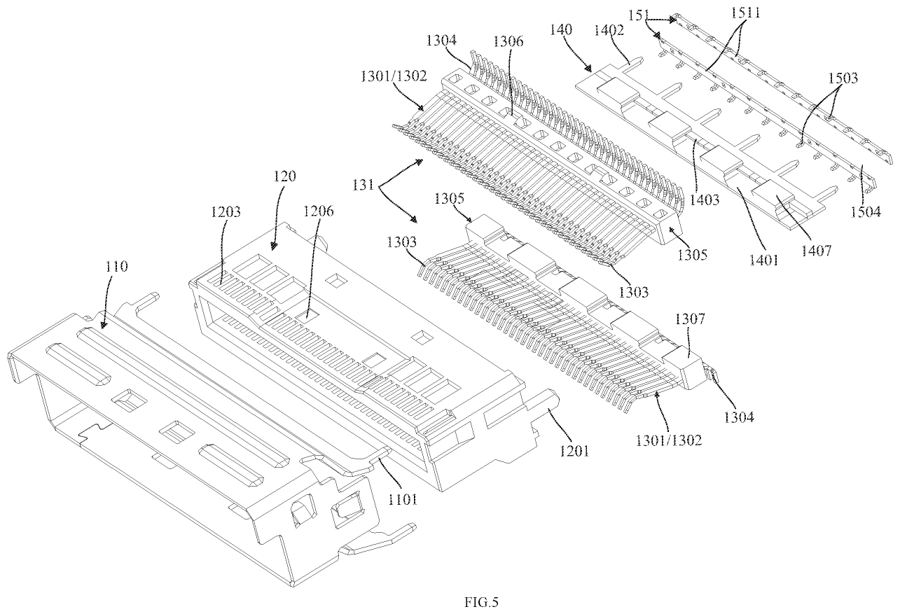

In the embodiment shown in FIGS. 2-4, the grounding member has a single plate-shaped body, while in the embodiment shown in FIG. 5-7, the grounding member comprises two sub grounding members 151 spaced apart from each other in the first direction X. Each sub grounding member 151 comprises a sub grounding body 1511 in a shape of a strip or a plate extending substantially in the second direction Y. The shielding member 140 is at least partially inserted into a gap 1504 between the sub grounding bodies 1511 of the two sub grounding members 151. The butting portion 1403 may be partially aligned with the sub grounding body 1511 of the grounding member 151 in the third direction Z, for example, may be butted against the sub grounding body 1511, so as to limit the position of the shielding member 140. As shown in FIGS. 5-7, a plurality of contact projections 1503 for contacting respective ground terminals 1302 are formed at an outer edge of the sub grounding body 1511 of each sub grounding member 151.

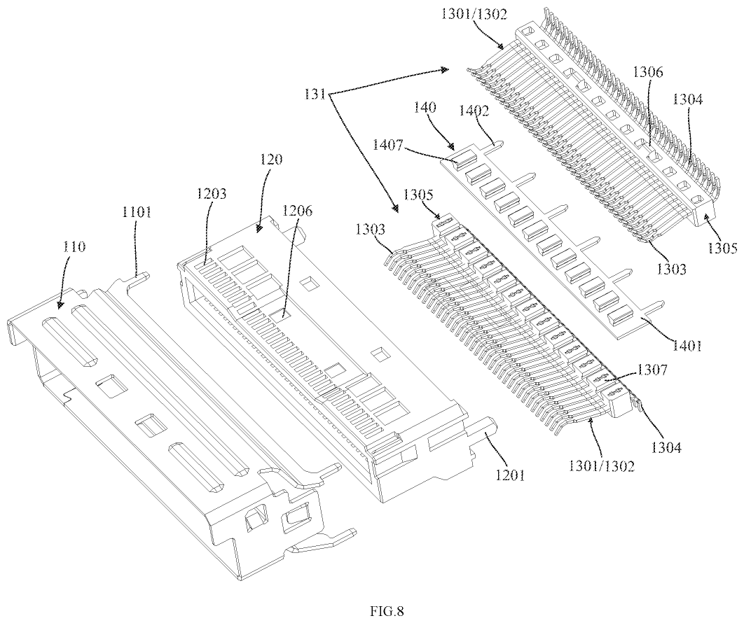

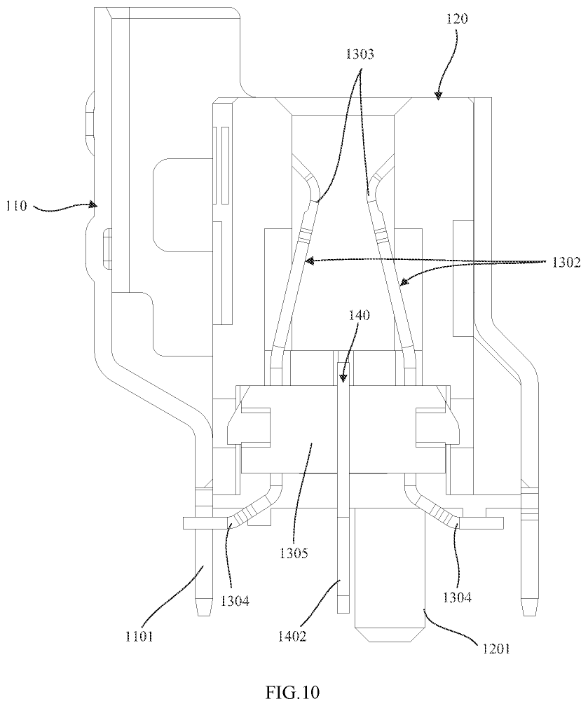

In the embodiments of FIG. 2-7, the shielding member 140 is electrically connected with the ground terminal by means of a grounding member provided separately, but the present disclosure is not limited thereto. Such a separate grounding member may not be provided in other embodiments. For example, in the embodiment shown in FIG. 8-10, the grounding member described above is not provided, and the shielding member 140 itself is grounded or in contact with a grounding component. In this embodiment, the contact leg 1402 of the shielding member 140 may extend longer or further from the shielding body 1401 in the third direction Z (as shown in FIG. 10), so as to make electrical contact with a grounding component (such as a grounding layer or trace) on a circuit board.

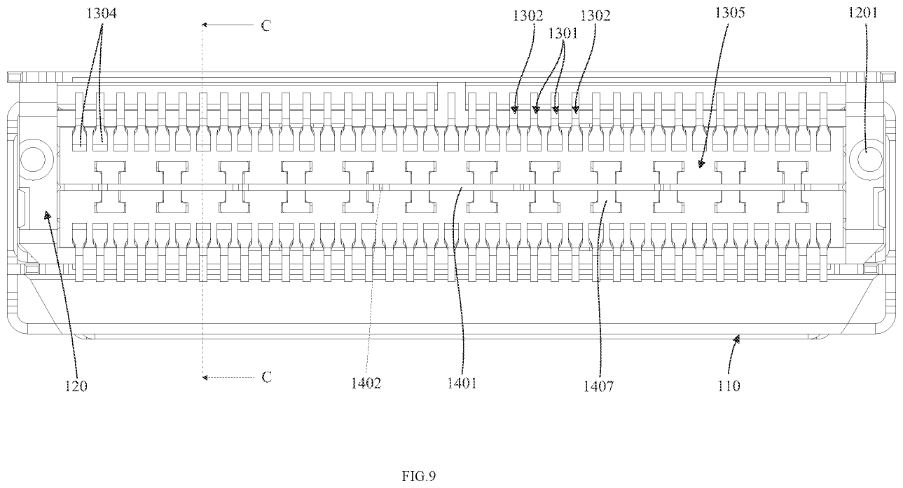

As shown in FIG. 9, the bump 1407 of the shielding member 140 may have a substantially T-shaped profile, so as to match with the shape of the gap or groove defined between adjacent protrusions 1307 of the installation base 1305. The bump 1407 may be positioned between adjacent ground terminals 1302 in the second direction Y, for example, substantially aligned with the signal terminal 1301 in the first direction X.

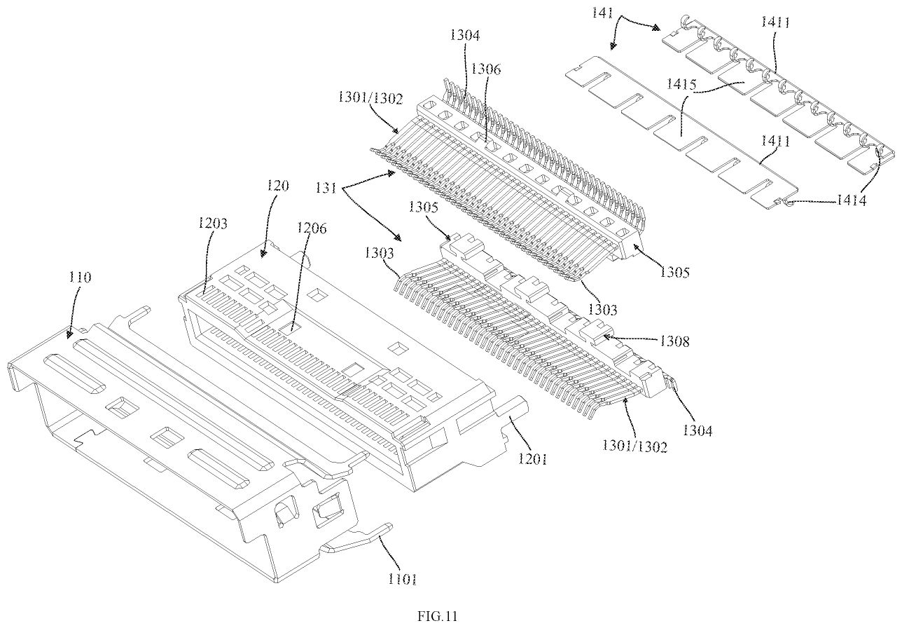

In the embodiments shown in FIGS. 11-16, the grounding member described above is not provided, and the shielding member itself is in electrical contact with the ground terminal 1302. As shown, the shielding member comprises a contact arm 1414 (e.g., an elastic arm) in electrical contact with the ground terminal 1302. The shielding member comprises two sub shielding members 141. Each sub shielding member 141 comprises a sub shielding body 1411 in a plate-shape, and the contact arm 1414 extends from an edge of the sub shielding body 1411 toward a corresponding ground terminal 1302. The two sub shielding bodies 1411 of the two sub shielding members 141 may be close to each other in the first direction X so that the contact arms 1414 of the two sub shielding members 141 are disposed away from each other so as to contact the ground terminal 1302 of the corresponding terminal assembly 131. As an example, each sub shielding member 141 may comprise a plurality of contact arms 1414 arrayed in the second direction Y, and the number of the contact arms 141 of each sub shielding member 141 is the same as the number of the ground terminals 1302 of each terminal assembly 131.

The contact arm 1414 may have a certain elasticity so as to butt against the ground terminal 1302 after being installed in place, thereby maintaining a stable contact between the contact arm 1414 and the ground terminal 1302. As an example, the contact arm 1414 may have or define together with the sub shielding body 1411, a substantially hook-shaped (such as a U-shaped or V-shaped) shape that is open in the third direction Z, so as to elastically butt against the ground terminal 1302.

Although the shielding member comprises two sub shielding bodies 1411 abutting against each other in the embodiments shown in FIG. 11-16, in other embodiments the shielding member may also comprise a single body and contact arms are provided on the two opposite sides of the single body.

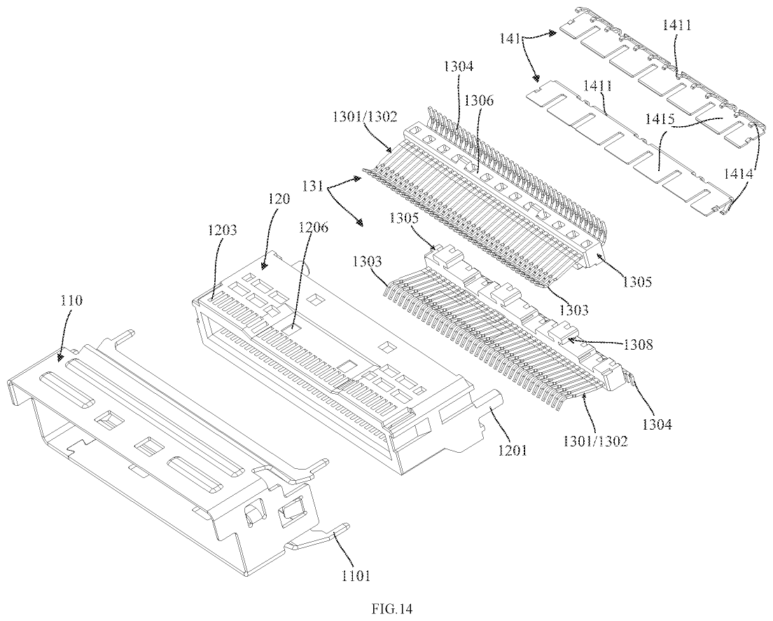

As shown in FIGS. 11 and 14, for example, an insertion protrusion 1308 defining an insertion slot is formed on a side wall of the installation base 1305 of the terminal assembly 131. For example, the insertion protrusion 1308 may have a substantially T-shaped profile, and the sub shielding body 1411 comprises an insertion portion 1415, which is adapted to be at least partially inserted into the insertion slot to fix the sub shielding body 1411 relative to the installation base 1305.

In the embodiments of the present disclosure, in addition to the ground terminals provided on either side of the signal terminals in the same row or in the same terminal assembly, the shielding member is also provided between the two adjacent terminal assemblies to circumferentially surround the signal terminals (e.g., differential signal terminal pair) together with the ground terminals, so as to further reduce signal interference, greatly improve the signal shielding effect, and better meet the SI performance requirements for high-speed data transmission. For example, as shown in FIG. 17, the solid line schematically represents the SI performance requirements or specifications for PCIe Gen6 on internal cables, the dotted line in portion (a) shows the power-sum near-end cross talk (PSNEXT) curve of a conventional connector, and the dotted line in portion (b) shows the PSNEXT curve of the electrical connector provided according to the embodiments of the present disclosure. It can be seen that with the electrical connector of the present disclosure, signal coupling and crosstalk are further reduced, and the performance margin is larger, which can well meet the SI performance requirements for PCIe Gen6 and be applicable for higher speed data transmission.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connector, comprising:
an outer housing;
an insulating housing arranged in the outer housing;
a pair of terminal assemblies arranged in the insulating housing and spaced apart from each other in a first direction to define an insertion space therebetween, the insertion space adapted to receive a connection terminal of a mating connector, each terminal assembly including a plurality of conductive terminals arranged in rows in a second direction perpendicular to the first direction, the plurality of conductive terminals of each terminal assembly including a signal terminal and a ground terminal; and
a shielding member at least partially positioned between the pair of terminal assemblies in the first direction and including a contact arm in electrical contact with the ground terminal.

2. The electrical connector according to claim 1, wherein the shielding member is at least partially positioned between the signal terminals of the pair of terminal assemblies in the first direction.

3. The electrical connector according to claim 2, wherein:
each conductive terminal defines a contact section adapted to make electrical contact with the connection terminal of the mating connector and an opposite installation section adapted to be installed on a circuit board, and
the shielding member is positioned at least partially between portions of the signal terminals of the pair of terminal assemblies in the first direction.

4. The electrical connector according to claim 2, wherein the plurality of conductive terminals of each terminal assembly include at least one pair of differential signal terminals and at least one corresponding pair of ground terminals, and each pair of ground terminals is positioned on two opposite sides of a corresponding pair of differential signal terminals in the second direction.

5. The electrical connector according to claim 1, wherein:
the shielding member includes two sub shielding members, each sub shielding member having a sub shielding body in a plate shape and the contact arm extending from an edge of the sub shielding body toward a corresponding ground terminal; and
the two sub shielding bodies of the two sub shielding members abut against each other in the first direction such that the contact arms of the two sub shielding members are disposed away from each other.

6. The electrical connector according to claim 5, wherein each terminal assembly further includes an installation base into which the plurality of conductive terminals of each terminal assembly are installed in one or more rows.

7. The electrical connector according to claim 6, wherein the installation base is formed with an insertion protrusion defining an insertion slot.

8. The electrical connector according to claim 7, wherein the sub shielding body comprises an insertion portion adapted to be at least partially inserted into the insertion slot and fixing the sub shielding body relative to the installation base.

9. The electrical connector according to claim 5, wherein each sub shielding member includes a plurality of contact arms arranged in the second direction, and the number of the plurality of contact arms of each sub shielding member is equal to the number of the ground terminals of each terminal assembly.

10. The electrical connector according to claim 1, wherein the contact arm has a hook shape that is open in a third direction perpendicular to the first direction and the second direction.

11. The electrical connector according to claim 1, further comprising a grounding member in electrical contact with the ground terminal, the shielding member electrically connected with the ground terminal via the grounding member.

12. The electrical connector according to claim 11, wherein the grounding member includes a grounding body having a middle socket, and the middle socket adapted to permit the shielding member to be at least partially inserted therein.

13. The electrical connector according to claim 11, wherein the grounding member includes two sub grounding members spaced apart from each other, and the shielding member is at least partially inserted into a gap between the two sub grounding members.

14. The electrical connector according to claim 11, wherein the grounding member comprises a contact projection configured to contact the ground terminal.

15. The electrical connector according to claim 1, wherein the shielding member has a contact leg for making electrical contact with a grounding component on a circuit board.

16. The electrical connector according to claim 1, wherein each terminal assembly further comprises an installation base into which the plurality of conductive terminals of each terminal assembly are installed in one or more rows.

17. The electrical connector according to claim 16, wherein a plurality of protrusions are formed on a side of each installation base facing another terminal assembly and are spaced apart from each other, and a groove is defined between adjacent protrusions.

18. The electrical connector according to claim 17, wherein the shielding member comprises a single shielding body, a plurality of bumps are formed on two opposite sides of the shielding body facing the installation base, each bump is adapted to be at least partially positioned in the groove between adjacent protrusions of corresponding installation bases.

19. An electrical connector, comprising:
an outer housing;
an insulating housing arranged in the outer housing;
two terminal assemblies arranged in the insulating housing and defining an insertion space therebetween adapted to receive a connection terminal of a mating connector, each terminal assembly including a plurality of conductive terminals arranged in rows; and
a shielding member at least partially positioned between the two terminal assemblies and including a contact arm in electrical contact with a ground terminal of each terminal assembly.

20. The electrical connector according to claim 19, wherein the shielding member includes two sub shielding members, each sub shielding member having a sub shielding body, the contact arm extending from an edge of the sub shielding body toward a corresponding ground terminal.
